(19) United States
(12) Patent Application Publication
(10) Pub. No.: US 2011/0137886 A1
(43) Pub. Date: Jun. 9, 2011

(54) Data-Centric Search Engine Architecture

(75) Inventors: Ji-Rong Wen, Beijing (CN); Guomao Xin, Beijing (CN); Yunxiao Ma, Beijing (CN); Yu Chen, Beijing (CN); Qing Yu, Beijing (CN); Yi Liu, Beijing (CN); Zhicheng Dou, Beijing (CN); Shuming Shi, Beijing (CN)

(73) Assignee: Microsoft Corporation, Redmond, WA (US)

(21) Appl. No.: 12/632,821

(22) Filed: Dec. 8, 2009

(51) Int. Cl. G06F 17/30

(52) U.S. Cl. 707/709; 707/E17.108

(57) ABSTRACT

Described is a data-centric web search engine technology/architecture, in which document metadata, including offline-extracted metadata, is used as part of a search indexing and ranking pipeline. A web data management component receives crawled documents and extracts document metadata from the documents. An indexing component uses the document metadata to build an index for the documents. A serving component uses the index and the document metadata to serve content, e.g., search results. Also described is the use of query metadata extracted from queries of a query log for use in the pipeline.

### BACKGROUND

The architecture of contemporary web search engines is process-centric. A crawler crawls documents (web pages) from the web, and feeds them into a document processor. The document processor performs webpage parsing, word-breaking and feature extraction. Based on the extracted data, the pages are indexed for ranking to return results corresponding to what the ranker deems the most relevant pages.

However, in this architecture, there is only a limited amount of time to process the web pages. As a result, only relatively lightweight processing is possible, whereby the analysis of web documents is relatively shallow. Further, the architecture provides a tightly coupled system that in general lacks flexibility and extensibility. For example, a small change in one part of the system may create an adverse effect (a “ripple effect”) in the entire system. Also, there is a general lack of capabilities with respect to data management, as web data is scattered and often transient, making it difficult to accumulate knowledge about the data.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a data-centric web search engine technology/architecture, in metadata including offline-extracted metadata, is part of an indexing and ranking pipeline. A large central data store is used to manage the data in the search engine. Other components retrieve data from the store and store the processed result back to the store, rather than operating via a pipeline method. For example, the crawling component retrieves URLs from the store to crawl, extracts document metadata from the downloaded documents, and stores these data into back into the store. An indexing component retrieves the document metadata to build an index for the documents. A serving component uses the index and the document metadata to serve content, e.g., search results.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example data-centric search engine architecture.

FIG. 2 is a block diagram representing components within the data-centric search engine architecture.

FIG. 3 is a representation of index building and updating of groups of documents used in the data-centric search engine architecture.

FIG. 4 is a representation of the data-centric architecture that differentiates between document understanding and query understanding.

FIG. 5 is a representation of document understanding including various tools for collecting document metadata.

FIG. 6 is a representation of query understanding including various tools for collecting query metadata.

FIG. 7 shows an illustrative example of a computing environment into which various aspects of the present invention may be incorporated.

### DETAILED DESCRIPTION

Various aspects of the technology described herein are generally directed towards a data-centric web search engine architecture, in which a web data management component based upon a data store (repository) including metadata is part of the indexing and ranking pipeline. As will be understood, this facilitates deeper document understanding and query understanding.

A crawler crawls pages from the web and places them into the repository. The document processor reads web pages from the repository, extracts page features and then stores the newly extracted features back into the repository. The indexer retrieves pages from the repository to build an inverted index. As a result, significant knowledge may be accumulated, and otherwise time-consuming feature extraction tasks may be performed to provide more desirable search results for queries.

It should be understood that any of the examples herein are non-limiting. Indeed, one particular architecture is described, however this is only one example. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and webpage processing/search technology in general.

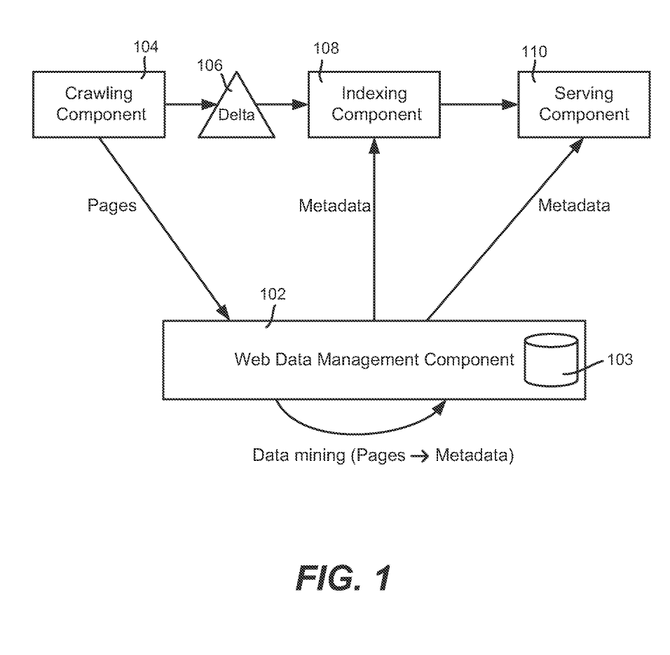

Turning to FIG. 1, there is shown an architecture of an indexing pipeline including a web data management component 102 that includes or is otherwise associated with a data store 103, (e.g., incorporated into a number of machines, such as on the order of 1,500 in one implementation). Note that the web data management component 102 and data store 103 can be considered to be part of the same module.

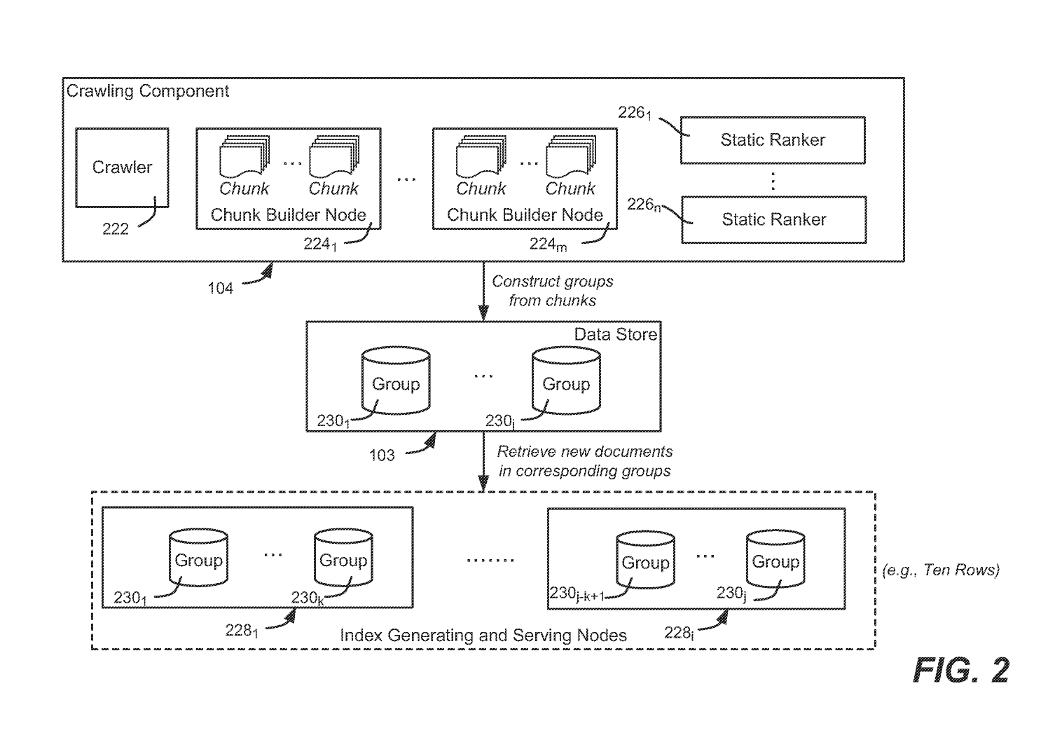

A crawling component 104 (as also represented in FIG. 2) comprising a crawler 222, chunk builder (nodes 224₁-224ₘ, where m is on the order of 300 nodes in one implementation) and static rankers 226₁-226ₙ, (where n is on the order of 200 in one implementation) provides pages to the web data management component 102. In general, the crawling component 104 crawls web pages, computes static rank, collects anchor text, and extracts some useful metadata for each document. The chunk builder nodes and static ranker module(s) are used to provide the crawler with feedback (e.g., newly discovered URLs, re-crawled URLs and static rank files).

As described below, the chunk builder nodes 224₁-224ₘ build chunks that are sent to the web data management component 102. Note that the crawling component 103 also provides changes (deltas) 106 to an indexing component 108 for updating the inverted index over time. In one alternative, the crawler directly outputs the delta changes to the indexer. In another alternative, the crawler stores the data into the data store and the indexer fetches the delta changes from the store, e.g., by a timestamp. (Note that the former is generally more efficient, while the latter is more flexible as it is a synchronized method.)

The web data management component 102 performs data mining on the crawled pages to obtain metadata for those pages. The mined metadata is provided to the indexing component 108 to build the inverted index. The mined metadata is also provided to a serving component 110 that uses the index and metadata to serve search results. Note that the indexing component 108 and serving component 110 can be considered/run together as an index generating and serving (IGS) component (e.g., IGS nodes 228₁-228ᵢ, FIG. 2) that incrementally retrieves data from the data store 103 and performs index building, merging and serving.

Among other actions, the web data management component 102 manages chunks by groups (e.g., groups 230₁-230ⱼ, FIG. 2, where j is on the order of 100,000 in one implementation), and provides persistent storage for metadata and possibly crawled documents. Note that a chunk is an existing unit for document processing and indexing in a contemporary pipeline. More particularly, web documents are saved into groups by a mapping function, such as GroupId(d)=Hash(d.URL) % GroupNum, where d is a document, and GroupNum is the number of groups. Other mapping functions are feasible, provided they divide documents into groups with each group having approximately the same number of documents. Differences between chunks and groups include that the mapping from documents to groups is determined beforehand by a mapping function, whereas the assignment of documents to chunks depends on the order of pages as downloaded by the crawler. As a result, when a page is downloaded multiple times, different versions of the page are assigned into the same group, but are likely to be assigned in different chunks. Another difference is that once a chunk has been built and published, its contents remain constant, with additional documents added into other chunks (with larger chunk IDs). When a chunk retires or expires, so do all documents contained in it. In contrast, groups are updated whenever new documents for that group are available or old documents are determined to be deleted. Yet another difference is that chunks are randomly assigned to index serving node machines and there is no guarantee that different versions of the same document are placed on the same index serving node. For groups, however, different versions of the documents in the same group are processed in the same machine, no matter when or in what order they are crawled. The table below summarizes some of the differences between chunks and groups:

| | Chunk | Group |
|---|---|---|
| The mapping from documents to | By Chance | Fixed |
| chunks/groups | | |
| The content of a chunk/group | Static | Dynamic |
| Set of chunks/groups in the system | Changing | Constant |
| Assigning different versions of a document | Not | Guaranteed |
| into the same index serving node | Guaranteed | |

The crawling component 102 thus acts as the content provider, and continuously (or regularly) provides content chunks to the rest of the system. In general, the crawler, chunk builder and static ranker modules of the crawling component 102 are the same as or very similarly to the existing process-centric architecture, however, page-download-failure information may be recorded such that the index generation and serving node has sufficient information to remove outdated pages. More particularly, the download-failure information of a URL may be used, e.g., if a URL keeps returning an HTTP 404 response (the path does not exist), it is not indexed or removed from the index even if it has a large static rank.

In addition, a document-adding tool may be built on each crawler and chunk builder machine to import the crawler-generated chunks into the data store 103, namely monitor a content chunk folder and add new content chunks into the data store 103. Note that once successfully added into the data store, it can be deleted from the crawler and chunk builder machine.

The data store 103 thus provides persistent storage for crawled documents and re-organizes them into the groups. In one implementation, an interface AddDocuments is provided for use by the document-adding tool to feed chunks into the store. Another interface, RetrieveDocs, is provided for each index generation and serving node to retrieve newly-crawled documents according to any specified conditions, e.g., a time range. To identify newly crawled or added documents, the crawling time or adding time of each document is used. For example, CrawlingTime>=#2008-12-05 19:10:00# specifies documents crawled after 19:10:00, Dec. 5, 2008; AddTime>=#2007-12-05 19:00:00# AND AddTime<#2008-12-05 20:00:00# specifies documents added in one hour (from 19 to 20 o'clock, on Dec. 5, 2008). When no condition is specified, all documents in the group are retrieved.

The data of each group may be replicated to multiple machines to avoid data loss and to improve availability. The data store alternatively may be designed as a data transformation component that is only utilized for processing chunks into groups, without persistently storing the documents.

In one implementation, each index serving and generating node 228₁-228ᵢ indexes approximately 10 million documents and performs index serving based on the index. As can be seen in FIG. 2, if the data are partitioned into subsets among the index serving and generating nodes 228₁-228ᵢ by group, with each given an approximately equal number k of groups and with i being 2,000 machines, then k is fifty.

Similar to chunks in the existing pipeline, each group has a primary hosting node and two secondary nodes in each row. Only primary replicas are used for serving search. When some machines in a row are offline, one secondary replica of the corresponding groups participates in index serving. An index serving and generating node provides service most of time, however after a certain period of time (e.g., one day), it may stop serving and perform an index update. To perform index update, an index serving and generating node retrieves newly-crawled web pages from the data store module by calling its interfaces. Then, indices of the newly-crawled pages are built, one index per group. Thereafter, the new and existing indices of all groups are merged to generate a large index.

Note that newer versions of existing documents may be contained in the newly-crawled documents, however they will be in the same group as the previous version. Further, some existing documents may need to be deleted because they have disappeared from the web. Still further, with the newly-crawled documents being added, the overall number of documents may exceed the desired number (e.g., 10 million) forone node, whereby additional nodes may be needed. A URL table may be built and used to deal with these situations.

More particularly, to select 10 million pages (in this example) for each IGS node, a URL table is maintained for each group, referred to as the group URL table, containing the URLs of the group which are in current index. In one implementation, the URL table contains the following information:

| Item(s) | Description |
|---|---|
| UrlHash | The hash value of the URL |
| UrlString | The raw string of the URL |
| StaticRank, | Some documents have high quality inlinks although |
| RefreshFrequency, | their content is expired. DiscardCoefficient indicates |
| DiscardCoefficient | whether to discard these pages when updating the |
| | index. |
| GroupId, DocOffset | These two items to record the location of the URL |

StaticRank, RefreshFrequency, and DiscardCoefficient are used to calculate a score (referred to as PageF) for each URL, with PageF then used as a measure to select documents. Other information also may be used in the PageF calculation.

The system gets the new documents for each group. The information to calculate PageF may be included in the content header as current hdc header:

```
Routine ComputePageFThreshold
Input:
  New document collection;
  Group URL tables;
Output:
  PageFₜₕᵣₑₛ
  // Collect all PageF
  Intialize a hash table Url2PageFHashmap; // <UrlHash, PageF>
  For each new document
    Calculate PageF for the document;
    Url2PageFHashmap.Add(doc.UrlHash, PageF);
  EndFor;
  For each group URL table
    For each entry of the URL table
      If (!Url2PageFHashmap.Contains(entry.UrlHash))
        Url2PageFHashmap.Add(entry.UrlHash, entry.PageF);
      EndIf;
    EndFor;
  EndFor;
  // Get PageF threshold
  Intialize an array PageFArray;
  Dump all PageF in Url2PageFHashmap to PageFArray;
  Perform quicksort on PageFArray;
  Select the 10,000,000^{th} largest score as PageF_{thres;}
  End routine
```

To select 10 million pages, a threshold for PageF is determined. The pages whose PageF are larger than the threshold are selected for the index. Note that indexing may include the URLs of new documents never seen before as well as new versions of current pages. The PageF for these pages are based on the new information. One suitable update process is described below:

```
Routine UpdateGroupUrlTable
Input:
  Group URL table;
  Group content file;
  New content of the group;
Output:
  Updated group URL table;
  Group NADInfo;
  Group NRDInfo;
// Key is UrlHash and value contains information of URL table entry
in addition to
// RawDocOffset which indicates the offset in the new documents of
the group
Initialize a hash table Url2NewPageInfoHashmap;
For each new document of the group
  Url2NewPageInfoHashmap.Add(document.UrlHash, documentInfo);
EndFor;
// Create a new group URL table which contains updated information
Initialize a new group URL table NewGroupUrlTable;
For each entry of current group URL table
  If (Url2NewPageInfoHashmap.Exist(entry.UrlHash)
    Add the document information to group NRDInfo;
  Else // this URL hasn't been updated
    If (entry.PageF > PageFₜₕᵣₑₛ)
      NewGroupUrlTable.Add(entry);
    Else // the document is below the threshold
      Add the document information to group NRDInfo;
    EndIf;
  EndIf; // whether the document has new version
EndFor; // for each entry of the current group URL table
// Dump the information of new documents
For each entry of Url2NewPageInfoHashmap in order of RawDocOffset
  If (hashEntry.PageF > PageFₜₕᵣₑₛ)
    Add the document information to group NADInfo;
    // Output the entry information to NewGroupUrlTable
    // DocOffset is assigned according to the design of content update
    NewGroupUrlTable.Add(CreateUrlEntry(hashEntry);
  EndIf;
EndFor; // each entry of Url2NewPageInfoHashmap
End routine
```

After getting the threshold PageFₜₕᵣₑₛ for PageF, the system updates each group URL table with certain changes, namely some entries are removed, because their PageF are below PageFₜₕᵣₑₛ, some entries are updated, because they have new versions, and some entries need to be added, because they have not been seen before. Note that the GroupId and DocOffset are updated for new version to append the new version documents to the group content file in content update. For a new document, the correct GroupId and DocOffset are provided.

Because not all of the new documents are selected, information about which pages are selected in this update is output, referred to as group NADInfo. Group NADInfo contains two types of information, namely documents which have not been seen before in this group with a PageF larger than PageFₜₕᵣₑₛ, and documents which have been seen in this group with their new PageF are larger than PageFₜₕᵣₑₛ, that is, new versions of current documents.

Another additional output is the information about which pages need to be removed for each group, referred to as group NRDInfo. Group NRDInfo contains documents having a new version, and documents that do not have a new version but have their PageF below PageFₜₕᵣₑₛ.

For content update, a content file is maintained for each group that contains the documents in the group index file. The group content files can be used to generate captions for search results. Based on group NADInfo, corresponding documents from the new documents may be appended to the old group content file.

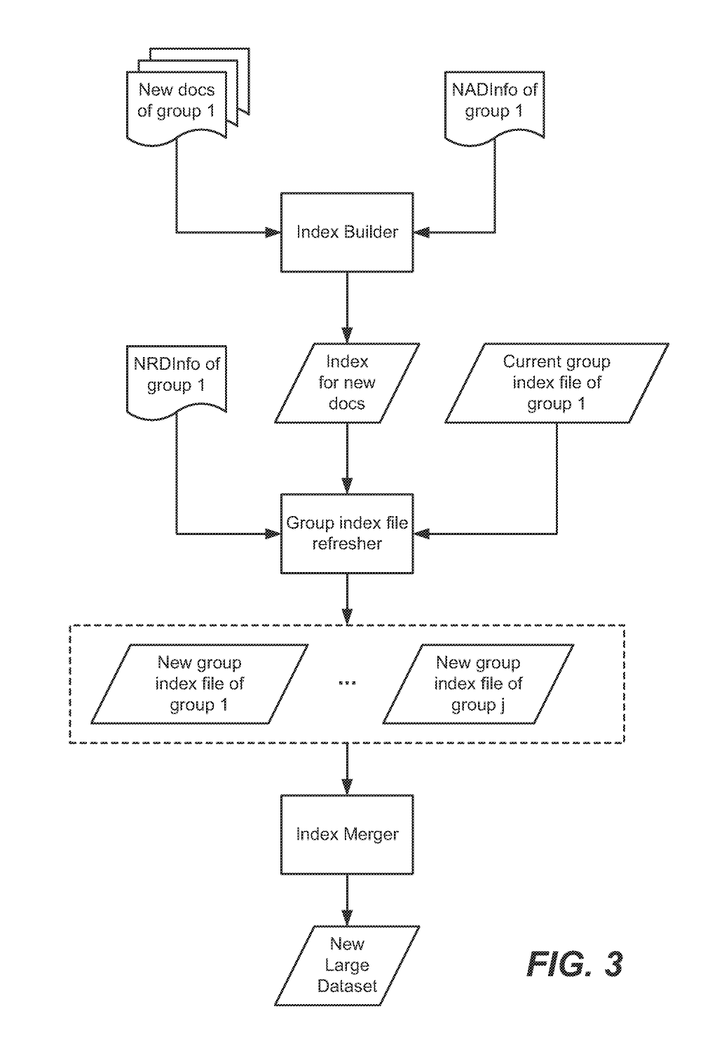

For index update, represented in FIG. 3, the system builds an index for the new documents of each group based on group NADInfo. Then the current group index file is updated with the index file of the new documents and group NRDInfo. After the group index files are updated, an index merge operation is performed to get an updated, large index.

Based on the NADInfo of the group, the documents that need to be added to the new index are known. The system first builds an index for these new documents for adding to the group index file later. To refresh group index files, the system removes the information of outdated documents using group NRDInfo and adds information from the index file of new documents.

In one implementation, three types of information are updated, namely DocData, to remove corresponding document data from the array based on group NRDInfo and add corresponding document data using group NADInfo, EndDocLocations, to remove corresponding locations based on group NRDInfo and make changes to other locations caused by the removing. New locations are added for the new documents, and TermLocations, which is similar to EndDocLocations.

A suitable group index file refresh process is shown below:

```
Routine RefreshGroupIndexFile
Input:
  Group index file;
  Group NRDInfo;
  Index file for the new documents of the group (IndexFileOfNewDocs);
Output:
  Updated group index file;
Initialize a new index file (NewGroupIndexFile);
/// Write document data array
DocDataArray = LoadDocData(GroupIndexFile);
// Remove responding document data from DocDataArray based on group
NRDInfo
DocDataArray = RemoveNRDocData(DocDataArray, NRDInfo);
DocDataArrayOfNewDocs = LoadDocData(IndexFileOfNewDocs);
// Adjust DocId in DocDataArrayOfNewDocs to reflect that
// append the new documents to group content file
DocDataArrayOfNewDocs = AdjustDocId(DocDataArrayOfNewDocs);
DocDataArray = DocDataArray + DocDataArrayOfNewDocs;
NewGroupIndexFile.DocData = DocDataArray;
/// Write end doc locations
EndDocLocs = LoadEndDocLocs(GroupIndexFile);
// Remove corresponding locations based on group NRDInfo
EndDocLocs = RemoveNREndDocLocs(EndDocLocs, NRDInfo);
EndDocLocsOfNewDocs = LoadEndDocLocs(IndexFileOfNewDocs);
// Make changes to the related locations in EndDocLocs caused by the
removement
NewEndDocLocs = AdjustEndDocLocsCausedByRemoving(EndDocLocs);
// Adjust the locations in EndDocLocsOfNewDocs to reflect that
// append the new documents to group content file
NewEndDocLocsOfNewDocs =
AdjustEndDocLocsCausedByAppending(EndDocLocsOfNewDocs);
AllEndDocLocs = NewEndDocLocs + NewEndDocLocsOfNewDocs;
Deltas[i] = NewEndDocLocs[i] − EndDocLocs[i];
Deltas_{new}_docs[j] = NewEndDocLocsOfNewDocs[j] −
EndDocLocsOfNewDocs[j];.
NewGroupIndexFile.EndDocLocations = AllEndDocLocs;
/// Write term locations
For each term
  Initialize a new term location list (NewTermLocs);
  TermLocs = LoadTermLocs(term, GroupIndexFile);
  // Remove term locations based on group NRDInfo
  TermLocs = RemoveNRDTermLocs(TermLocs, NRDInfo);
  For each TermLoc of TermLocs
    DocIndex = FindDocIndex(TermLoc; EndDocLocs);
    // Adjust the location of the term
    NewTermLocs.Add(TermLoc + Deltas[DocIndex]);
  EndFor;
  TermLocsOfNewDocs = LoadTermLocs(IndexFileOfNewDocs);
  For each TermLoc of TermLocsOfNewDocs
    DocIndex = FindDocIndex(TermLoc, EndDocLocsOfNewDocs);
    // Adjust the location of the term
    NewTermLocs.Add(TermLoc + Deltas_{new}_docs[DocIndex]);
  EndFor;
  NewGroupIndexFile.TermLists.Add(term, NewTermLocs);
EndFor;
NewGroupIndexFile.Write( );
End routine
```

After group index files are updated, a known index merger merges the index files to provide an updated, large index for serving.

Note that the above steps do not actually remove the outdated documents from group content files. These documents are “dead” because they will disappear from the index after the index file is updated. In one implementation, these documents are not immediately removed from the group content files because removing them results in a write that is close to a backup of all the old group content files, even though the number of these documents is relatively small. Instead, the documents are cleaned out when there are a sufficient number of these documents (e.g. more than 5 million). Note that updating the group URL table to remove dead documents causes changes to the DocOffset of some documents. Also, with respect to the group content file, the dead documents of each group are documents that do not exist in the group URL table, and these are removed from the group content file. For the group index file, the Dodd of some documents is updated because their DocOffset numbers in the group content file are changed due to the removal of dead documents. With respect to the large index, instead of doing extra updates after the incremental indexing process, the system may make small changes to each step (document selection, content update, and index update) to do a clean update.

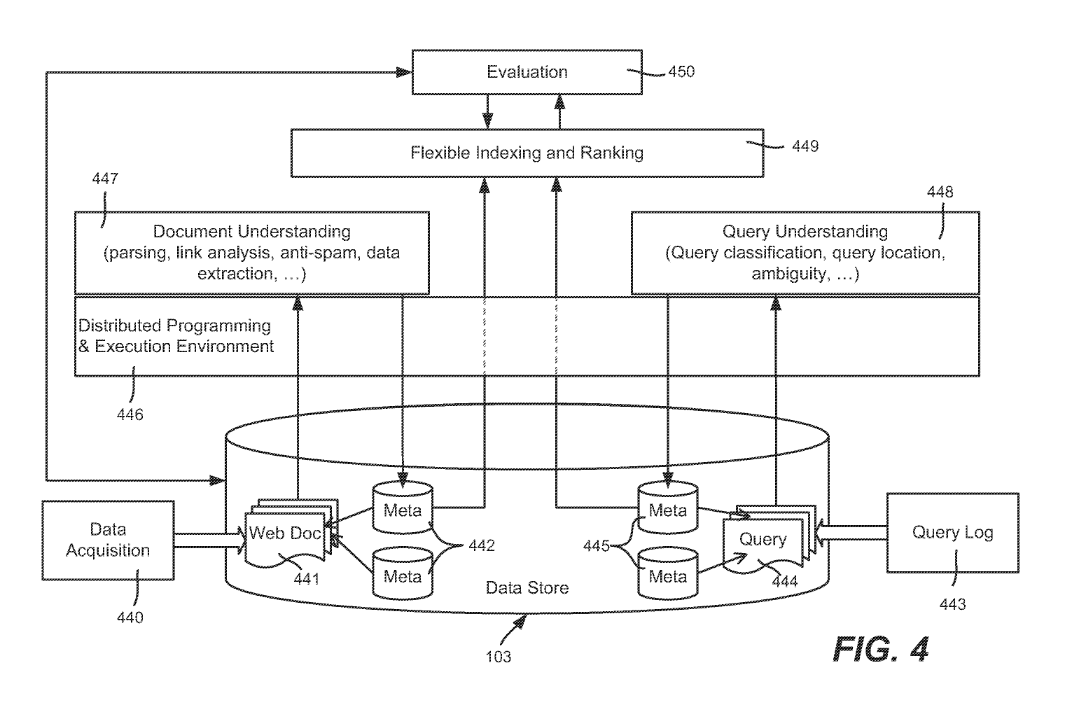

FIG. 4 shows another perspective of the architecture, in which the data store 103 is filled by a data acquisition process 440 to store the web documents 441 and extracted document metadata 442 in an offline process. The data store 103 further includes information mined from a query log 443 about queries 444 and query metadata 445 corresponding to those queries.

Thus, in general, as part of the above-described nodes that provide a distributed programming and execution environment 446, a document understanding process 447 provides the document metadata 442, while a query understanding process 448 provides the query metadata 445. Via a flexible indexing and ranking mechanism 449, evaluation 450 may be performed on the data and metadata, such as described in U.S. patent application Ser. No. ______ (attorney docket no. 327766.01), and Ser. No. ______ (attorney docket no. 327768.01), entitled Experimental Web Search System and “Flexible Indexing and Ranking for Search,” respectively, hereby incorporated by reference.

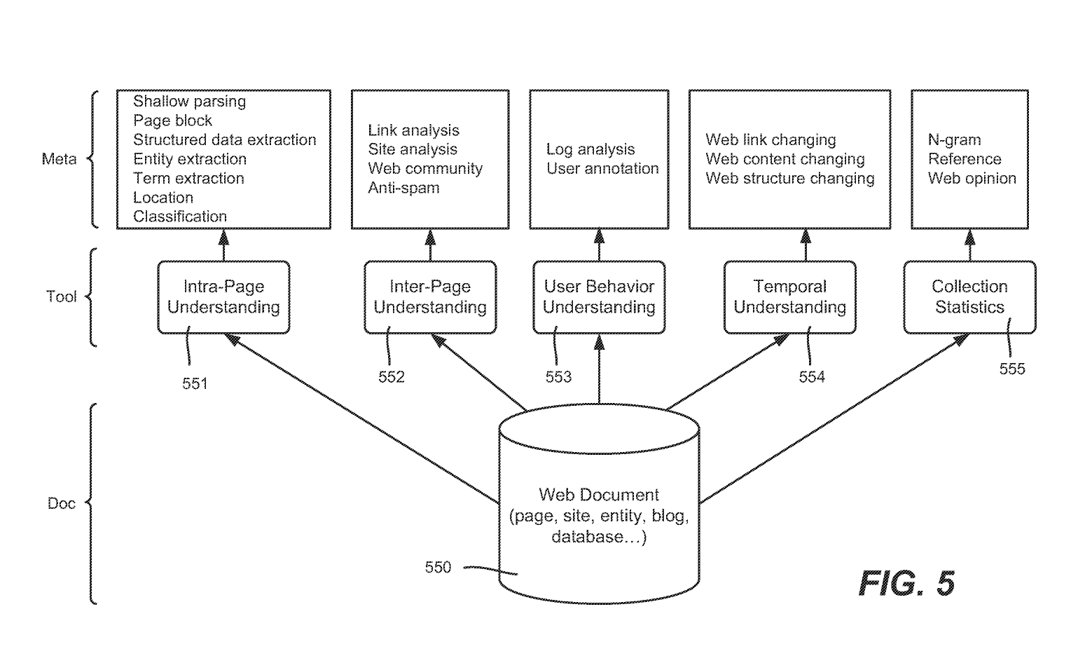

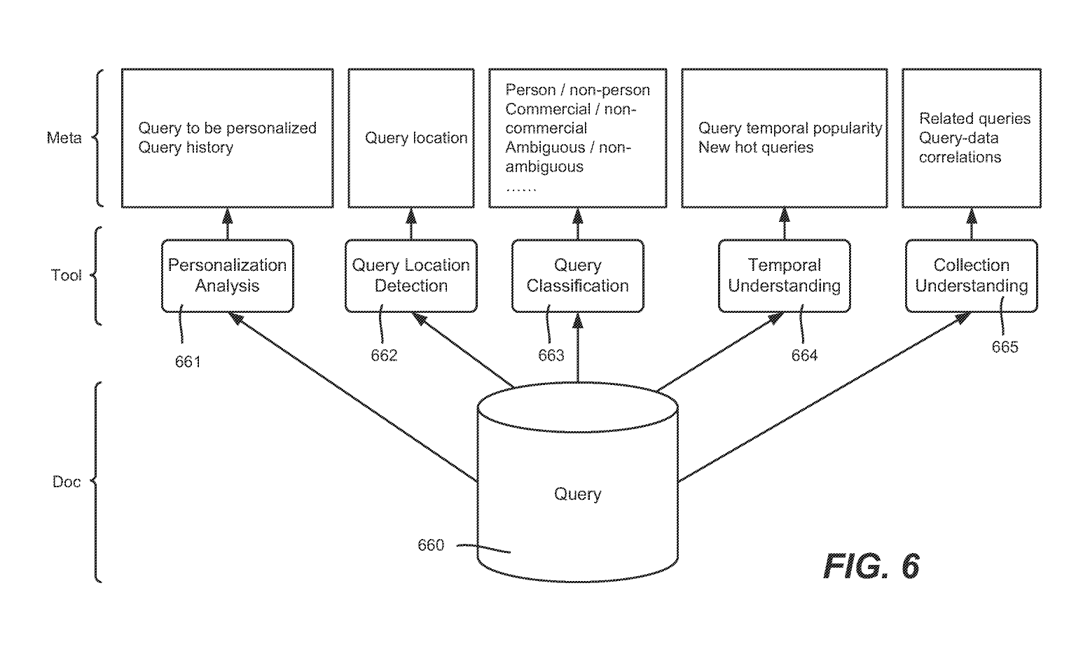

FIG. 5 shows some of the possible document metadata 442 that may be extracted from a document 550 (within the data store 103) via the document understanding process. Various tools 551-555 are illustrated to show some of the types of metadata that may be extracted. FIG. 6 shows some of the possible query metadata 445 that may be extracted from a query 660 (within the data store 103) via the query understanding process. Various tools 661-665 are illustrated to show some of the types of metadata that may be extracted.

### Exemplary Operating Environment

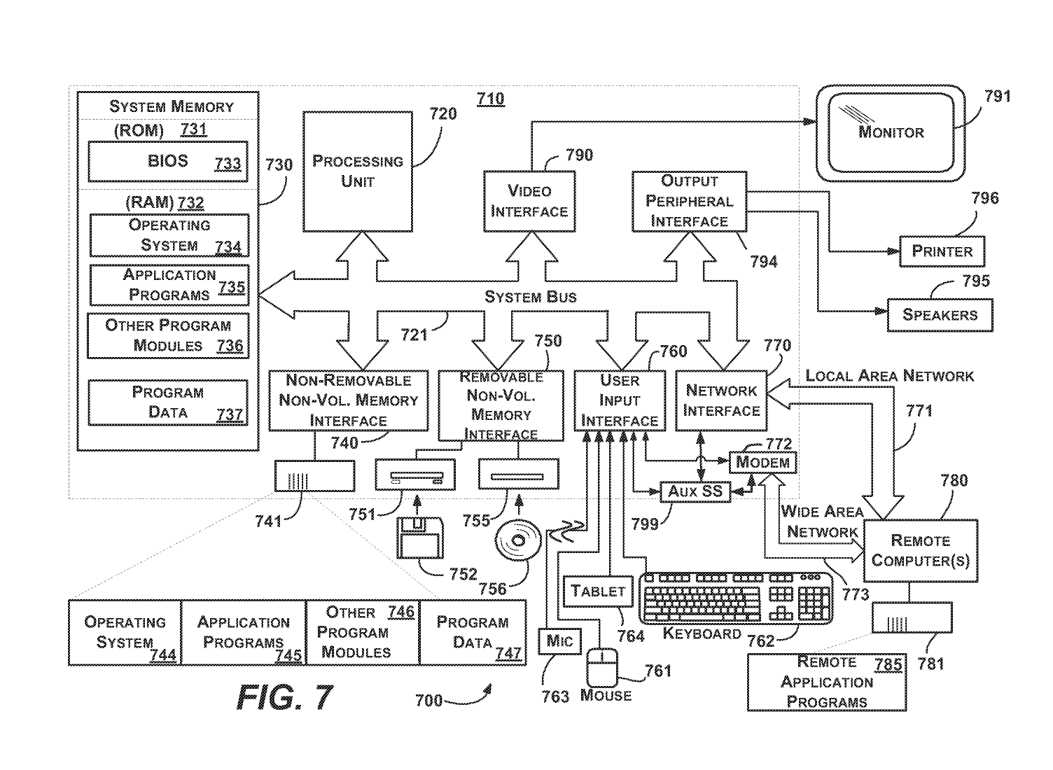

FIG. 7 illustrates an example of a suitable computing and networking environment 700 on which the examples of FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising, a crawling component that provides documents, a web data management component that receives the documents and extracts document metadata from the documents, an indexing component that uses the document metadata to build an index for the documents, and a serving component that uses the index and the document metadata to serve content.

2. The system of claim 1 wherein the web data management component is associated with a data store that stores the document metadata.

3. The system of claim 2 wherein the web data management component includes an interface for adding data into the data store, including by the crawling component.

4. The system of claim 2 wherein the web data management component includes an interface for retrieving documents data from the data store, including by the indexing component or the serving component, or both the indexing component and the serving component.

5. The system of claim 1 wherein the crawling component includes a crawler, a chunk builder mechanism and a static ranker mechanism.

6. The system of claim 1 wherein the web data management component processes chunks of data into a set of groups by a mapping function, and wherein subsets of the set of groups are each processed by an index generating and serving node of a plurality of index generating and serving nodes.

7. The system of claim 1 wherein the indexing component updates the index based on incremental changes obtained from the crawling component.

8. The system of claim 1 wherein the indexing component updates the index based upon removal data, including data identifying documents having a new version, and documents below a threshold value.

9. The system of claim 1 wherein the document metadata includes intra-page understanding metadata, inter-page understanding metadata, user behavior understanding metadata, temporal understanding metadata or collection statistics metadata, or any combination of intra-page understanding metadata, inter-page understanding metadata, user behavior understanding metadata, temporal understanding metadata or collection statistics metadata.

10. The system of claim 1 wherein the document metadata includes shallow parsing metadata, page block metadata, structured data extraction metadata, entity extraction metadata, term extraction metadata, location metadata, classification metadata, link analysis metadata, site analysis metadata, web community metadata, anti-spam metadata, log analysis metadata, user annotation metadata, web link changing metadata, web content changing metadata, web structure changing metadata, n-gram metadata, reference metadata, web opinion metadata, or any combination of shallow parsing metadata, page block metadata, structured data extraction metadata, entity extraction metadata, term extraction metadata, location metadata, classification metadata, link analysis metadata, site analysis metadata, web community metadata, anti-spam metadata, log analysis metadata, user annotation metadata, web link changing metadata, web content changing metadata, web structure changing metadata, n-gram metadata, reference metadata, web opinion metadata

11. The system of claim 1 wherein the web data management component is associated with a data store that stores queries and query metadata extracted from a query log.

12. The system of claim 11 wherein the query metadata includes personalization analysis metadata, query location detection metadata, query classification metadata, temporal understanding metadata, or collection understanding metadata, or any combination of personalization analysis metadata, query location detection metadata, query classification metadata, temporal understanding metadata, or collection understanding metadata.

13. In a computing environment, a system comprising, a data store that maintains documents, a document understanding process that extracts document metadata from the documents and maintains the document metadata in the data store, a query understanding process that extracts query metadata from queries of a query log, document metadata and query metadata used by a serving component to provide search results in response to a query.

14. The system of claim 13 further comprising an indexing component that builds an index of the documents based upon the document metadata.

15. The system of claim 13 further comprising a crawling component that obtains the documents.

16. The system of claim 15 wherein the indexing component updates the index based upon new documents and different versions of documents provided by the crawling component.

17. The system of claim 15 wherein the crawling component provides chunks of data to the data store, and wherein the data store is associated with a web data management component that processes the chunks of data into groups by a mapping function.

18. In a computing environment, a system comprising, a crawling component that provides chunks of data corresponding to web documents to a web data management component, the web data management component processing the chunks of data into groups, the groups distributed among a plurality of index generating and serving nodes that create indexes from the groups and serve content based upon the indexes.

19. The system of claim 18 wherein the index generating and serving nodes include means for merging the indexes into a larger index for serving the content.

20. The system of claim 18 wherein the web data management component is associated with a data store that stores the documents, the document metadata, queries, and query metadata.
